(19) United States
(12) Patent Application Publication
(10) Pub. No.: US 2010/0321143 A1
(43) Pub. Date: Dec. 23, 2010

(54) INDUCTOR

(75) Inventors: Yuki SATAKE, Tokyo (JP); Tsutomu SATO, Tokyo (JP)

Correspondence Address: HOSOON LEE, 9600 SW OAK ST. SUITE 525, TIGARD, OR, 97223, US

(73) Assignee: SHINTO HOLDINGS CO., LTD, Tokyo (JP)

(21) Appl. No.: 12/446,230

(22) PCT Filed: Oct. 12, 2007
(86) PCT No.: PCT/JP2007/069969

§ 371 Date: Jun. 4, 2009

(30) Foreign Application Priority Data
Oct. 17, 2006 (JP) 2006-283118
Oct. 12, 2007 (JP) PCT/JP2007/069969

(51) Int. Cl. H01F 27/29

(52) U.S. Cl. 336/192

(57) ABSTRACT

Provided is an inductor which effectively uses a mounting space and has remarkably reduced radiation noise. The inductor is provided with a magnetic core (1) having a high magnetic permeability, and a coil element (2) integrally embedded in the magnetic core. The magnetic core (1) has a spherical structure, and the coil element (2) has a spherical coil structure wherein a coil conductive wire is spherically laminated. The extracting end of the coil element configures connecting terminals (2a, 2b) by extending to the external of the magnetic core. Since the coil element having the spherical coil structure is integrally embedded inside the magnetic core having the spherical structure, a leaking magnetic flux is remarkably reduced and the magnetic flux is prevented from being disturbed.

### TECHNICAL FIELD

The present invention relates to an inductor, and more particularly, to an inductor that can remarkably reduce a leaking magnetic flux and improve disturbance of magnetic flux.

### BACKGROUND ART

Various power circuits such as a DC-DC converter and the like are used in various electronic devices such as an AV device, an information processing device and the like. For example, a step-down DC-DC converter is used in case of supplying an LSI of a terminal device with power, and a stepped-down DC voltage is thus supplied to the LSI. Moreover, for a lightning circuit such as a discharge lamp and the like, an AC power voltage is stepped up by an inverter circuit, a stepped-up AC voltage is supplied to the discharge lamp and the like. In such the power circuits, the inductor is used, and development of inductors having excellent low loss property and DC bias property has been needed. As an inductor coping with this need, known is a choke coil with a coil element embedded in a magnetic core by disposing an insulation coated ferromagnetic metal powder and the coil element in a mold and performing a press forming (for example, referring to Patent Document 1).

Moreover, since a leaking magnetic flux is generated from an inductance element and radiation noise is transferred to peripheral circuit elements, it is important subject to develop an inductor which reduces a leaking magnetic flux and also prevents magnetic flux from being disturbed. As an inductance element which reduces radiation noise, known is an inductance element with a magnetic core an external appearance of which has about a spherical shape (for example, referring to Patent Document 2).

Patent Document 1: Japanese Patent Application Publication No. 2006-13066

Patent Document 2: Japanese Patent Application Publication No. 2005-109399

### DISCLOSURE OF THE INVENTION

### Problem to be Solved by the Invention

AV devices and information processing devices have been strongly requested to be compact, and also, an inductor has been strongly requested to be compact. However, the inductor disclosed in the Patent Document 1 has excellent DC bias property, hut, since the inductor has a rectangular shape, a dead space is made in a mounting space, and making the mounting area small is limited. Particularly, since the inductor is often mounted along with a chemical condenser on the same substrate, when a rectangular element in cross-section is arranged adjacent to a circular element in cross-section, there is a detect that a dead space on a substrate increases. Moreover, in case that a magnetic core encapsulating a coil element is rectangular, a magnetic flux is subject to leak from a core edge portion, and it is concerned that a peripheral circuit element is caused to be maloperated by secondary radiation.

Moreover, for an inductor which is used in various power circuits, since it is requested to develop an element having a higher inductance value, it is important matter to develop an inductor which is compact and has large winding numbers.

An object of the present invention is to provide an inductor which effectively uses a mounting space and also remarkably reduces irradiation noise. Further, another object of the present invention is to provide an inductor which is compact and has a high inductance value.

### Means for Solving the Problem

An inductor according to the present invention, which includes a magnetic core of high permeability or high saturation property, and a coil element integrally embedded in the magnetic core, is characterized in that the magnetic core has about a spherical structure, the coil element a spherical coil structure wherein a coil conductive wire is wound to have about a spherical external shape, and two extracting ends of the coil conductive wire configure connecting terminals by extending to the external of the magnetic core.

The present invention actively uses a characteristic effect of an inductor with a coil element embedded in a magnetic core. This type of inductor is manufactured by disposing an insulation coated magnet powder and a coil element in a mold and performing a press forming. Therefore, the inductor has a structure where the coil element is embedded in the magnetic core of high permeability or high saturation properly, and the magnetic core functions as a yoke of the coil element, and also, functions as a magnetic shield component shielding the external of the coil element since the magnetic core extends along a magnetic path of a magnetic flux produced from the coil element, and thus a strong magnetic shield for an external element works. Particularly, since the inductor has a spherical shape as a whole, a portion where a magnetic flux is emitted from the coil element has a spherical shape, and thus there are a remarkable effect that a leaking magnetic flux is hardly generated and disturbance of magnetic flux does not occur.

Moreover, since the coil element of the present invention has a spherical coil structure wherein an external shape of the coil element is spherical and the magnetic core has a spherical structure, plenty of windings per unit volume are formed, and as a result, provided is an inductor which does not have a large size and has a high inductance value.

Another inductor according to the present invention, which includes a magnetic core of high permeability or high saturation property, and a coil element integrally embedded in the magnetic core and configured by a coil conductive wire which is flat in cross-section and plurally wound, is characterized in that the magnetic core has about a spherical structure, two extracting ends of the flat coil conductive wire configuring the coil element configure connecting terminals by extending to the external of the magnetic core. Even in case of using the coil element configured by the flat wire plurally wound, by using a magnetic core having a spherical structure, provided is an inductor which hardly generates a leaking magnetic flux and does not produce disturbance of magnetic flux.

A preferred embodiment of the inductor is characterized in that two extracting ends of a coil conductive wire configure connecting terminals, respectively, by being bent perpendicularly to the coil conductive wire configuring a winding portion of the coil, the two connecting terminals are located at the same plane which is parallel to a center axis line of the coil element, and the inductor is surface-mounted on a circuit board through the two flat connecting terminals. As such, by only forming one bending portion as in forming the extracting end of the coil element, a surface mount type inductor is provided. In the present embodiment, since only one bending portion is formed, obtained is an inductor wherein it is hard for the coil conductive wire to be disconnected even though a press forming is performed, and thus, production efficiency is improved.

### EFFECT OF THE INVENTION

Since an inductor according to the present invention uses a magnetic core having a spherical structure, realized is an inductor which hardly generates a leaking magnetic flux and does not produce disturbance of magnetic flux. Moreover, since the magnetic core is spherical, when mounted on a circuit hoard, the problem is solved that an unnecessary dead space is made. Particularly, it is advantageous in being mounted along with a chemical condenser on a circuit board

### BRIEF DESCRIPTION OF THE DRAWINGS

FIG. 1 is views illustrating an example of an inductor according to the present invention.

FIG. 2 is views illustrating a modified example of an inductor according to the present invention.

FIG. 3 is views illustrating another modified example of an inductor according to the present invention.

### DESCRIPTION OF THE SYMBOLS

1 and 11: magnetic core
2 and 12: coil element
2a, 2b, 12a and 12b: connecting terminal
3: inner space
4: circuit board
L: center axis line

### BEST MODE FOR CARRYING OUT INVENTION

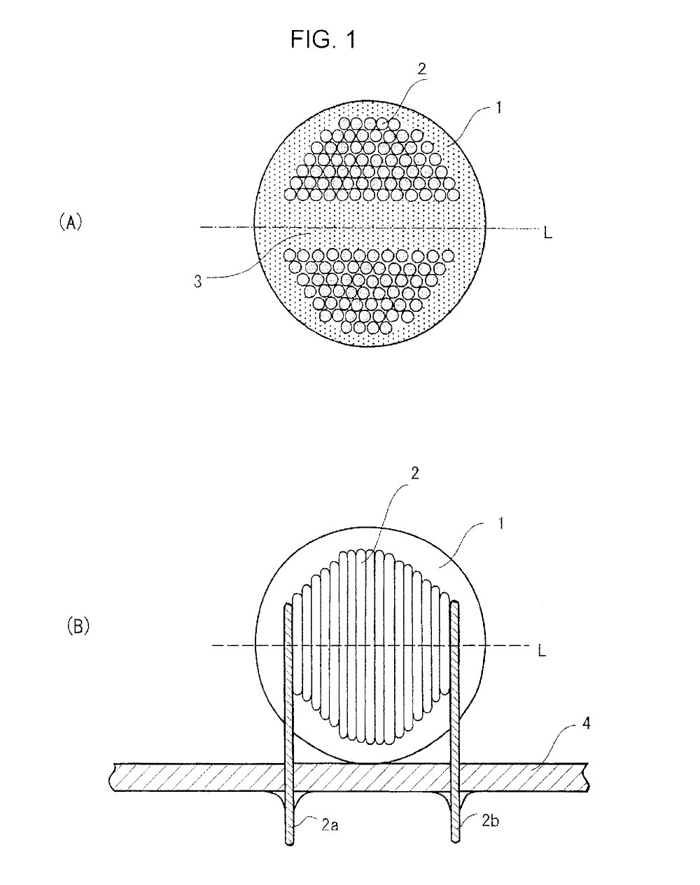

FIG. 1 is views illustrating an example of an inductor according to the present invention, FIG. 1A is a cross-sectional view taken along a plane (which is a plane perpendicular to a coil conductive wire) including a center axis line of a coil element, and FIG. 1B is a view illustrating a state that the inductor is mounted on a circuit board. The inductor according to the present invention includes a magnetic core 1 of high permeability, and a coil element 2 integrally embedded in the magnetic core 1. The inductor according to the present invention is manufactured by disposing an insulation coated magnet powder and a coil element 2 in a mold and performing a press forming. The magnetic core 1 has substantially a spherical structure in external shape and shields the external of the coil element embedded inside. Therefore, the magnetic core 1 configures a core which has a magnetic shield effect of shielding a magnetic flux produced from the coil element 2 and also a yoke formed in an inner space 3 of the coil element 2. The coil element 2 is an air core coil which is configured by winding a common copper wire coated with urethane and the like, and a coil conductive wire is wound such that the external surface of the coil element has almost a spherical shape. Therefore, the coil element 2 has a spherical coil structure wherein the coil conductive wire is spherically laminated.

As shown in FIG. 1B, the inductor of the present embodiment is configured as what is called a DIP type inductor. When mounted on a circuit board 4, two extracting ends 2a and 2b of the coil conductive wire extending to the external of the magnetic core 1 are inserted into holes formed at the circuit board and fixed by soldering.

Since the coil element 2 has a spherical structure and the magnetic core 1 also has a spherical structure, a winding number per unit volume of the inductor of the present embodiment greatly increases compared with an inductor which is rectangular in cross-section, and thus an inductor having high inductance value is realized. Moreover, since the magnetic core is spherical as a whole thus a portion where a magnetic flux is emitted from the coil element is spherical, a problem is greatly improved that disturbance of magnetic flux is produced. Moreover, since the core of high permeability or high saturation property exists along a magnetic path of a magnetic flux produced from the coil element, radiation noise due to a leaking magnetic flux is hardly generated, and it is possible that other circuit element is arranged close to the inductor.

A method of manufacturing an inductor according to the present invention is explained as follows. In the present invention, the inductor is manufactured by performing a press forming integrally for an insulation coated magnet powder and a coil element, or by performing a press forming for a mix powder of an electrically-insulating binder and a high permeability magnet powder, and a coil element. As the magnet powder, for example, one magnet metal or more, for example, of iron, carbonyl iron, iron silicide, permalloy (Fe—Ni), supermalloy (Fe—Ni—Mo), sendust, iron nitride, iron-aluminum alloy, iron-cobalt alloy and the like may be used. Further, as an insulating material or insulating binder coating the magnet powder, an insulating material selected from various inorganic insulating materials, for example, silicon oxide and the like, or various organic insulating materials may be used. To be concrete, for example, it is selected from silicon oxide, water glass, phenolic resin, silicon resin, exposy resin and the like.

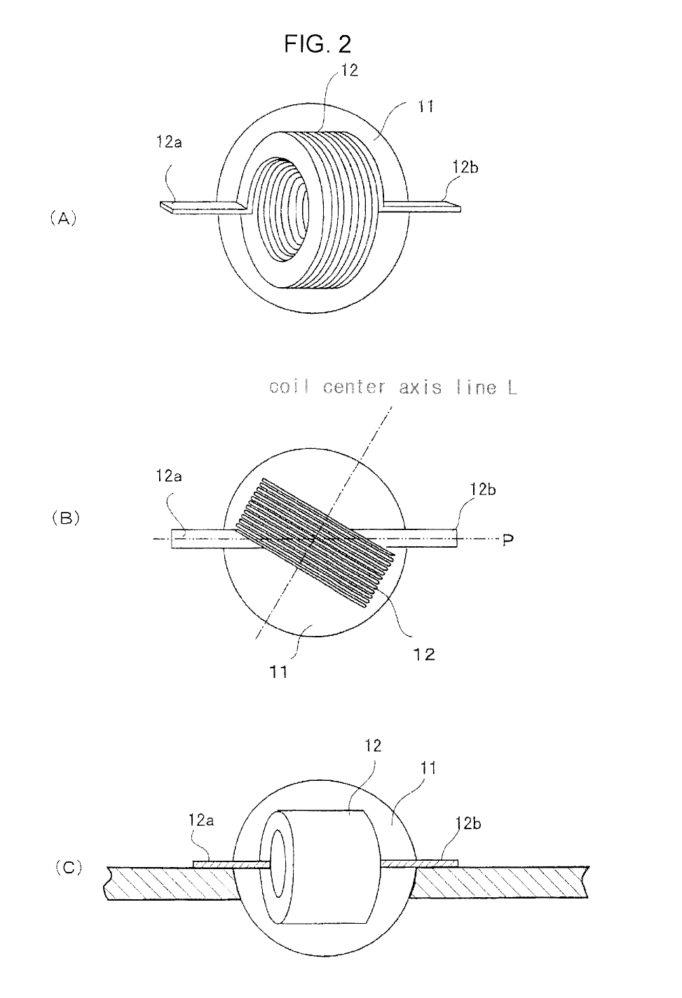

FIG. 2 is views illustrating a modified example of an inductor according to the present invention and shows the inductor which is very suitable for surface mount on a circuit board. FIG. 2A shows configuration of a coil element embedded in a magnetic core, FIG. 2B is a top view of the inductor, and FIG. 2C is a view illustrating a state that the inductor is surface mounted on a circuit board. The inductor includes a magnetic core 11 of high permeability, and a coil element 12 embedded in the magnetic core. The coil element 12 uses an air core coil which is configured by plurally winding a flat conductive wire, which has a flat shape in cross-section, coaxially. Two extracting ends of the coil conductive wire configure connecting terminals 12a and 12b which are bent perpendicularly to the coil element. The two flat connecting terminals 12a and 12b are located at the same plane parallel to a center axis line 1, of the coil element. Further, the two flat connecting terminals 12a and 12b extends in opposite directions along an axis line P, which is located at said plane, with the coil element therebetween. By this configuration, since the two connecting terminals 12a and 12b function as supporting components, realized is the inductor for which it is possible to be surface mounted on the circuit board.

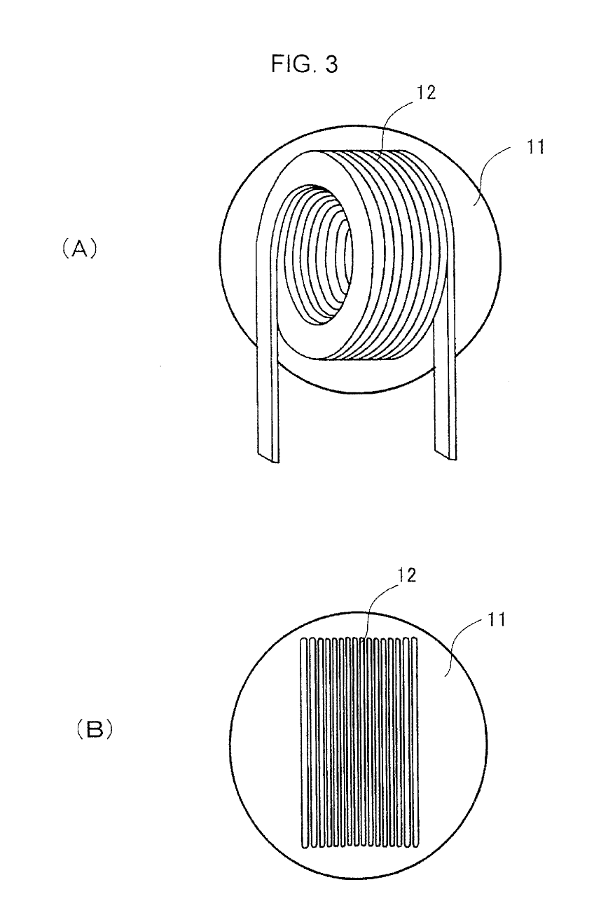

FIG. 3 shows another modified example of an inductor according to the present invention. In this embodiment, provided is a DIP type element by using a coil element where a flat conductive wire is wound. In case of the DIP type inductor, extracting ends 12a and 12b of a coil element extend straight and are used as connection terminals.

What is claimed is:

1. An inductor, which comprises a magnetic core having high permeability or high saturation property, and a coil element integrally embedded in the magnetic core, characterized in that the magnetic core has about a spherical coil structure wherein a coil conductive wire is wound to have about a spherical external shape, and two extracting ends of the coil conductive wire configure connecting terminals by extending to the external of the magnetic core.

2. The inductor according to claim 1, wherein the coil element is configured by an air core coil, and wherein the magnetic core configures a yoke inside the air core coil and a core covering the external of the air core coil.

3. An inductor, which comprises a magnetic core having high permeability, and a coil element integrally embedded in the magnetic core and configured by a coil conductive wire which has a flat shape in cross-section and is plurally wound, characterized in that the magnetic core has about a spherical coil structure, and two extracting ends of the flat-shaped coil conductive wire configuring the coil element configure connecting terminals by extending to the external of the magnetic core

4. The inductor according to claim 3, wherein the two extracting ends of the coil conductive wire configure the connecting terminals, respectively, by being bent perpendicularly to the coil conductive wire configuring a coil winding portion, wherein the two connecting terminals are located at the same plane which is parallel to a center axis line of the coil element, and wherein the inductor is surface mounted on a circuit board through the two flat-shaped connecting terminals.

5. The inductor according to claim 4, wherein the two extracting ends of the coil conductive wire are perpendicularly bent such that each connecting terminal extends in opposite directions along the same axis line which is located at the same plane.

6. The inductor according to one of claims 1 to 5, manufactured by performing a press forming integrally for an insulation coated magnet powder and a coil element or by performing a press forming integrally for a mix powder of an electrically-insulating binder and a magnet powder of high permeability and a coil element.
